(19) United States
(12) Patent Application Publication
(10) Pub. No.: US 2019/0049777 A1
(43) Pub. Date: Feb. 14, 2019

(54) DISPLAY PANEL AND DISPLAY DEVICE

(71) Applicant: SHENZHEN CHINA STAR OPTOELECTRONICS TECHNOLOGY CO. LTD., Shenzhen, Guangdong (CN)

(72) Inventor: Dongze LI, Shenzhen, Guangdong (CN)

(73) Assignee: Shenzhen China Star Optoelectronics Technology Co., Ltd., Shenzhen, Guangdong (CN)

(21) Appl. No.: 15/566,701

(22) PCT Filed: Aug. 24, 2017
(86) PCT No.: PCT/CN2017/098821

§ 371 Date: Oct. 14, 2017

(30) Foreign Application Priority Data
Jul. 21, 2017 (CN) 2017105997994

(51) Int. Cl. G02F 1/1335; G02F 1/13357

(52) U.S. Cl. CPC G02F 1/133512; G02F 1/133504; G02F 2202/36; G02F 1/1336; G02F 2001/133614; G02F 1/133528

(57) ABSTRACT

A display panel includes: a first substrate, a second substrate, and a liquid crystal layer located between the first and second substrates. The first substrate includes red sub-pixels, green sub-pixels, and blue sub-pixels arranged in an array, with the red sub-pixels filled with red quantum dots, the green sub-pixels with green quantum dots, and the blue sub-pixels with transparent scattering particles. The blue backlight module is located on a side of the second substrate away from the liquid crystal layer and provides blue backlight for the display panel. A display device is further disclosed. The blue backlight is configured to excite the red quantum dots to scatter red light and the green quantum dots to scatter green light, and configured to be re-scattered by the transparent scattering particles to increase, together with the red light and the green light, the display brightness of the display panel at large viewing angles.

This application claims the benefit of Chinese Patent Application No. 201710599799.4, filed Jul. 21, 2017, and entitled “DISPLAY PANEL AND DISPLAY DEVICE”, which is hereby incorporated herein by reference in its entirety.

### TECHNICAL FIELD

The present disclosure relates to display technology, and more particularly relates to a display panel and a display device.

### BACKGROUND

With the development of science and technology as well as social progress, people are increasingly dependent on information exchange and delivery. Display devices, especially liquid crystal displays (LCDs), as the major carrier and material basis of information exchange and transmission, have become the focus of more and more people's attention, and are widely used in all aspects of people's work and life.

The viewing angle of the LCD has always been one of the important evaluation criteria of the LCD's display effects. In existing technology, such LCDs as a TN or VA LCD have preferable brightness at the right viewing angle, but at larger viewing angles the displays are poor with significantly lowered brightness, resulting in large differences in brightness between the LCD's larger viewing angles and the right viewing angle-hence imbalance of brightness among various viewing angles and poor display effects, affecting the user experience.

### SUMMARY

This disclosure provides a display panel and a display device for addressing the problem in the related art of the large differences in brightness between the LCD's larger viewing angles and right viewing angle leading to unbalanced brightness across various angles and therefore poor display effects, which affect the user experience.

In order to address the technical problem mentioned above, the present disclosure provides a display panel disposed opposite to and laminated with a blue backlight module. The display panel includes a first substrate, a liquid crystal layer, and a second substrate, with the liquid crystal layer located between the first substrate and the second substrate. The first substrate includes red sub-pixels, green sub-pixels, and blue sub-pixels arranged in an array. The red sub-pixels are filled with red quantum dots, the green sub-pixels are filled with green quantum dots, and the blue sub-pixels are filled with transparent scattering particles. The blue backlight module is located on a side of the second substrate away from the liquid crystal layer and provides blue backlight for the display panel. The blue backlight may be configured to excite the red quantum dots and the green quantum dots to scatter red light and green light, respectively. The blue backlight also may be configured to be scattered by the transparent scattering particles and then the scattered blue light can increase, together with the red light and the green light, the display brightness of the display panel at large viewing angles.

In one implementation, the display panel further includes a first polarizer and a second polarizer. The first polarizer located between the first substrate and the liquid crystal layer. The second polarizer on a side of the liquid crystal layer away from the first polarizer. The first polarizer is configured to collimate the blue backlight to improve the scattering effect of the blue backlight across the transparent scattering particles.

In one implementation, the red sub-pixels, the green sub-pixels, and the blue sub-pixels each may include a light entrance and a light outlet. The light entrance is located on a side of the first substrate facing the liquid crystal layer. The light outlet is located on a side of the first substrate away from the liquid crystal layer. The light entrance may be larger in size than the light outlet thus increasing the angles at which the red light, the green light, and the blue backlight emit from the display panel.

In one implementation, the first substrate further includes a black matrix located among the red sub-pixels, the green sub-pixels, and the blue sub-pixels.

In one implementation, the second polarizer is located on a side of the second substrate away from the liquid crystal layer.

In one implementation, the transparent scattering particles include inorganic nano-particles and resin microspheres.

In one implementation, the transparent scattering particles have diameters in the range of 10 nm to 1 μm.

In one implementation, the red quantum dots and the green quantum dots have a material system of acrylic-acid-based, epoxy-based, or polyolefin-based resins.

In one implementation, the display panel further includes a transparent cover plate located on a side of the first substrate away from the liquid crystal layer.

This disclosure further provides a display device that includes a blue backlight module and a display panel. The display panel includes a first substrate, a liquid crystal layer, and a second substrate, with the liquid crystal layer located between the first substrate and the second substrate. The first substrate includes red sub-pixels, green sub-pixels, and blue sub-pixels arranged in an array. The red sub-pixels are filled with red quantum dots, the green sub-pixels are filled with green quantum dots, and the blue sub-pixels are filled with transparent scattering particles. The blue backlight module is located on a side of the second substrate away from the liquid crystal layer and provides blue backlight for the display panel. The blue backlight may excite the red quantum dots and the green quantum dots to scatter red light and the green light, respectively. The blue backlight also can be scattered by the transparent scattering particles. The scattered blue light can increase, together with the red light and the green light, the display brightness of the display panel at large viewing angles. The blue backlight module may be located on a side of the second substrate away from the liquid crystal layer and can provide blue backlight for the display panel.

In one implementation, the display panel further includes a first polarizer and a second polarizer. The first polarizer is located between the first substrate and the liquid crystal layer. The second polarizer is located on a side of the liquid crystal layer away from the first polarizer. The first polarizer is configured to collimate the blue backlight to improve the scattering effect of the blue backlight by the transparent scattering particles.

In one implementation, the red sub-pixels, the green sub-pixels, and the blue sub-pixels each include a light entrance and a light outlet. The light entrance is located on a side of the first substrate facing the liquid crystal layer. The light outlet is located on a side of the first substrate away from the liquid crystal layer. The light entrance may be larger in size than the light outlet thus increasing the angles at which the red light, the green light, and the blue backlight emit out of the display panel.

In one implementation, the first substrate further includes a black matrix located among the red sub-pixels, the green sub-pixels, and the blue sub-pixels.

In one implementation, the second polarizer is located on a side of the second substrate away from the liquid crystal layer.

In one implementation, the transparent scattering particles include inorganic nano-particles and resin microspheres.

In one implementation, the transparent scattering particles have diameters in the range of 10 nm to 1 μm.

In one implementation, the red quantum dots and the green quantum dots have a material system of acrylic-acid-based, epoxy-based, or polyolefin-based resins.

In one implementation, the display panel further includes a transparent cover plate located on a side of the first substrate away from the liquid crystal layer.

With aid of the technical solutions provided herein, the blue backlight provided by the blue backlight module can sequentially pass through the second substrate and the liquid crystal layer before irradiating the first substrate. The blue backlight can be configured to excite the red quantum dots to scatter red light, and the green quantum dots to scatter green light. The red light and the green light generated by the quantum dot materials can then be scattered in all directions outside the display panel. The blue backlight can also emit blue light to the outside of the display panel through the transparent scattering particles which can re-scatter the blue light. Therefore, by the scattering effects of the blue light obtaining a widened light pattern together with the red and green light, the LCD's display brightnesses at large viewing angles can be improved, the gradient of the brightness change starting from the right viewing angle towards the large viewing angles can be moderated, leading to balanced brightness across various viewing angles, hence improved viewing angle performance and user experience.

### BRIEF DESCRIPTION OF THE DRAWINGS

In order to better illustrate the technical solutions of embodiments of the disclosure, the accompanying drawings for use with the description of the embodiments will be briefly described below. It will be apparent that the drawings described in the following represent merely some embodiments of the disclosure, and that those of ordinary skill in the art, without performing any creative work, will be able to obtain other drawings from these drawings, in which:

FIG. 1 is a schematic structural view illustrating a display panel in accordance with a first embodiment of the disclosure.

FIG. 2 is an enlarged schematic view illustrating a first substrate in accordance with the first embodiment of the disclosure.

FIG. 3 is a schematic view illustrating the emission of light out of the first substrate in accordance with the first embodiment of the disclosure.

FIG. 4 is a schematic structural view illustrating a display panel in accordance with a second embodiment of the disclosure.

FIG. 5 is a schematic structural view illustrating a display panel in accordance with a third embodiment of the disclosure.

FIG. 6 is a schematic structural view illustrating a display device in accordance with an embodiment of the disclosure.

### DETAILED DESCRIPTION OF ILLUSTRATED EMBODIMENTS

Hereinafter, technical solutions embodied by embodiments of the disclosure will be described in a clear and comprehensive manner in reference to the accompanying drawings intended for the embodiments. It is evident that the embodiments described herein constitute merely some rather than all of the embodiments of the disclosure, and that those of ordinary skill in the art will be able to derive other embodiments based on these embodiments without making inventive efforts, thus such derived embodiments shall all fall in the protection scope of the disclosure.

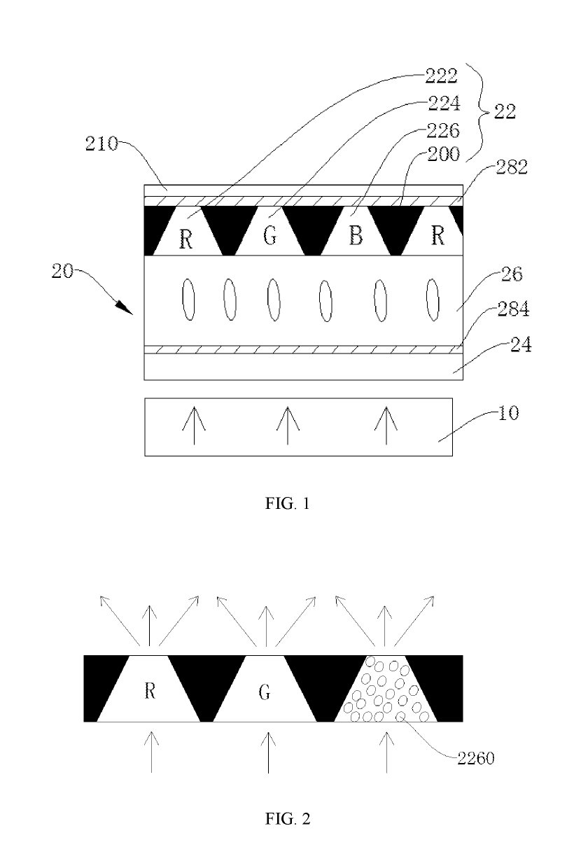

As illustrated in FIG. 1, a display panel 20 provided by a first embodiment of the disclosure may be disposed opposite to and laminated with a blue backlight module 10. The blue backlight module 10 may emit a blue backlight to enter the liquid crystal panel allowing the liquid crystal panel to display color image information for reception at the user's eyes. In one implementation, the display panel 20 is a liquid crystal display panel, which can adjust deflection angles of the liquid crystal molecules by a driving voltage applied thereto, so as to control the image displayed on the display panel 20.

The display panel 20 provided by the first embodiment of the disclosure may include a first substrate 22, a liquid crystal layer 26, and a second substrate 24. The liquid crystal layer 26 is located between the first substrate 22 and the second substrate 24. In one implementation, the first substrate 22 is a color film substrate, and the second substrate 24 is an array substrate, where the first substrate 22, the liquid crystal layer 26, and the second substrate 24 can be successively laminated and then sealed using a frame glue to form a liquid crystal cell. The first substrate 22 may provide a common voltage, while the second substrate 24 may provide a pixel voltage. Thus, deflection angles of the liquid crystal molecules can be adjusted by changing the voltage difference between the common voltage and the pixel voltage (i.e., the driving voltage).

Referring also to FIG. 2, the first substrate 22 may include red sub-pixels 222, green sub-pixels 224, and blue sub-pixels 226 arranged in an array. The red sub-pixels 222 are configured to emit red light, the green sub-pixels 224 are configured to emit green light, and the blue sub-pixels 226 are configured to emit blue light. As such, it is possible to display any color image by controlling the brightness and darkness as well as matching of the lights in three primary colors-red, green, and blue.

In this embodiment, the red sub-pixels 222 may be filled with red quantum dots, while the green sub-pixels 224 may be filled with green quantum dots. In one implementation, the red quantum dots and the green quantum dots are of a quantum dot (QD) material. Quantum dot materials are capable of converting the backlight (in this embodiment, the blue backlight provided by the blue backlight module 10) at high energy regions into controllable sub-pixels coming in three colors. For example, the red quantum dots can convert the blue backlight into red light, and the green quantum dots can convert the blue backlight into green light. Specifically, the quantum dot materials have on its own right optical conversion abilities, and when they are excited by the blue backlight, electron transition may occur, followed by the recombination of electrons and holes in the form of fluorescent radiation. The quantum dot materials, as typical zero-dimensional nano-materials, have dimensions in all directions lying within the quantum confinement range, hence no directional selectivity in the fluorescent radiation—the excited quantum dot materials will radiate undifferentiated fluorescence around 360°. Therefore, the red light and the green light emitted from the first substrate 22 will be scattered in all directions, which can effectively balance the brightness conditions across various viewing angles, lessening the gradient of the brightness change starting from the right viewing angle towards large viewing angles. In one implementation, the red quantum dots and the green quantum dots have a material system composed of acrylic-acid-based, epoxy-based, or polyolefin-based resins.

In this embodiment, the blue sub-pixels 226 are filled with the transparent scattering particles 2260. When the blue backlight is irradiated to the blue sub-pixels 226 of the first substrate 22, the blue backlight can pass through the transparent scattering particles 2260 to emit blue light outside the display panel 20. Specifically, when the blue backlight passes through the transparent scattering particles 2260, the blue light can be re-scattered and thus endowed with a widened light pattern, producing the blue light that scatter in all directions outside the display panel 20. As a result, the scattered blue light, combined with the scattering effects of the red light emitted by the red sub-pixels 222 and the green light emitted by the green sub-pixels 224, can allow all the light emitted from the display panel 20 to cover a relatively large display angle, thus achieving the purpose of improving the viewing angle.

In one implementation, the transparent scattering particles 2260 include inorganic nano-particles and resin microspheres. Specifically, the transparent scattering particles 2260 may include TiO2, SiO2, ZnO, etc., while the resin microspheres may include polystyrene, polymethylmethacrylate (PMMA), and the like. Both inorganic nano-particles and resin microspheres have good transparency, which can improve the transmittance of the blue backlight, and enable the blue light with a superb scattering effect.

In one implementation, the transparent scattering particles 2260 may have diameters in the range of 10 nm to 1 μm to increase their scattering effects on the blue backlight. Specifically, the inorganic nano-particles and resin microspheres each may have a diameter in the range of approximately 10 nm to 1 μm. Optionally, the inorganic nano-particles may have diameters of 20 nm, 100 nm, 500 nm, or 800 nm, while the resin microspheres may have diameters of 30 nm, 80 nm, 300 nm or 900 nm.

In this embodiment, the blue backlight module 10 may be located on a side of the second substrate 24 away from the liquid crystal layer 26 and provides blue backlight for the display panel 20. Specifically, the blue backlight module 10 emits blue light using blue light emitting diodes (LEDs). The blue light then may sequentially pass through the second substrate 24 and the liquid crystal layer 26 to reach the first substrate 22, and there cause the red sub-pixels 222, the green sub-pixels 224, and the blue sub-pixels 226 to emit scattered red light, green light, and blue light, respectively.

As described above, the blue backlight provided by the blue backlight module 10 can sequentially pass through the second substrate 24 and the liquid crystal layer 26 to reach the first substrate 22. There the blue backlight can excite the red quantum dots to emit red light, and the green quantum dots to emit green light. Thus, the red light and the green light generated by the quantum dot materials can then be scattered in all directions outside the display panel 20. The blue backlight can also transmit through the transparent scattering particles 2260 to emit blue light to the display panel 20, where the transparent scattering particles 2260 can re-scatter the blue backlight. Therefore, by the scattering effects of the blue light having obtained a widened light pattern combined with the red light and the green light, the LCD's display brightness at large viewing angles can be improved, the gradient of the brightness change starting from the right viewing angle towards the large viewing angles can be moderated, leading to balanced brightness across various viewing angles-hence improved viewing angle performance and user experience.

In this embodiment, the display panel 20 further may include a first polarizer 282 and a second polarizer 284 respectively disposed on opposite sides of the liquid crystal layer 26. The second polarizer 284 located between the liquid crystal layer 26 and the blue backlight module 10. Specifically, the blue backlight can be filtered by the second polarizer 284 and only the blue light having the same polarization as that of the second polarizer 284 will pass through. Then the deflected liquid crystal molecules may adjust the polarization of the blue light, leaving only the blue light that has been adjusted to be the same as the polarization of the first polarizer 282 to pass through the first polarizer 282.

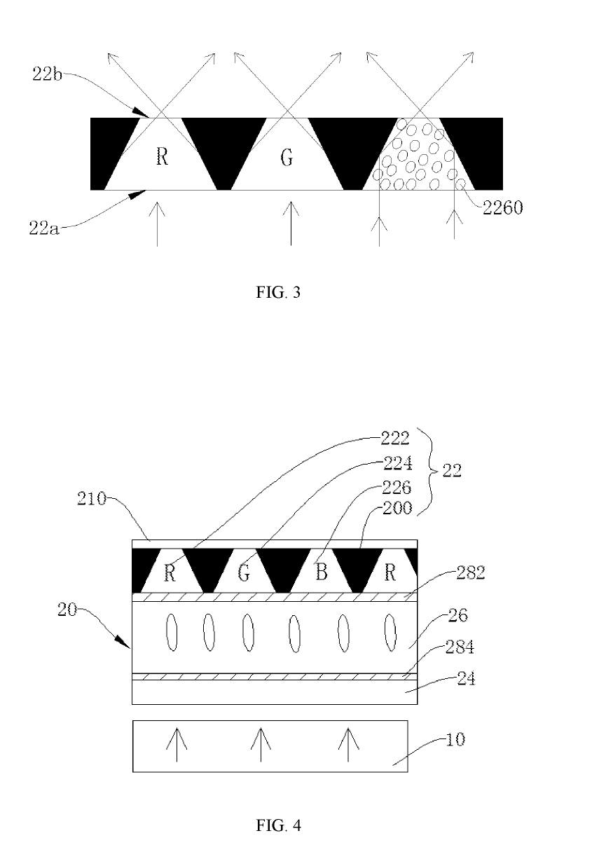

Referring also to FIG. 3, in this embodiment, the red sub-pixels 222, the green sub-pixels 224, and the blue sub-pixels 226 each may include a light entrance 22a and a light outlet 22b, with the light entrance 22a located on the side of the first substrate 22 facing the liquid crystal layer 26, and the light outlet 22b on the side of the first substrate 22 away from the liquid crystal layer 26. The light entrance 22a may be larger than the outlet 22b in size. Specifically, the red sub-pixels 222, the green sub-pixels 224, and the blue sub-pixels 226 each may have a trapezoidal cross section in the context of the cross section of the first substrate 22. In the red sub-pixels 222 and the green sub-pixels 224, their red quantum dots can be configured to be excited to emit red light and the green quantum dots to emit green light, and either of the red light and the green light can be reflected by the trapezoid's oblique side and emitted outside the light outlet 22b thus increasing the angles of the red light and the green light emitted outside the display panel 20. Likewise, in the blue sub-pixels 226, the blue light entering from the light entrance 22a can be reflected by the trapezoid's oblique side and emitted outside the light outlet 22b thus improving the angle of the blue light emitted from the display panel 20.

In one implementation, the first substrate 22 further includes a black matrix 200 arranged among the red sub-pixels 222, the green sub-pixels 224, and the blue sub-pixels 226. The black matrix 200 can fill the gaps among the red sub-pixels 222, the green sub-pixels 224, and the blue sub-pixels 226, and can be used to shield the opaque elements, such as pixel electrodes and the like, in the display panel 20.

Referring now to FIG. 4, the display panel 20 provided in the second embodiment of the disclosure differs from the first embodiment in that the first polarizer 282 is located between the first substrate 22 and the liquid crystal layer 26. Specifically, the blue light will have been filtered and collimated by the first polarizer 282 and the second polarizer 284 before shone to the first substrate 22, so that the blue light received by the red sub-pixels 222, the green sub-pixels 224, and the blue sub-pixels 226 would have the same polarization with more uniform incident directions. Thus on one hand, the stimulated emission effects of the red and green quantum dots can be improved, while on the other, the ordered blue light can obtain a better scattering effect after passing through the transparent scattering particles 2260.

As described above, the blue backlight provided by the blue backlight module 10 can sequentially pass through the second substrate 24 and the liquid crystal layer 26 before reaching the first substrate 22. There the blue backlight can excite the red quantum dots to emit red light, and the green quantum dots to emit green light. Thus, the red light and the green light generated by the quantum dot materials can then be scattered in all directions outside the display panel 20. The blue backlight also can transmit through the transparent scattering particles 2260 to emit blue light to the display panel 20, where the transparent scattering particles 2260 can re-scatter the blue backlight. Therefore, by the scattering effects of the blue light having obtained a widened light pattern combined with the red light and the green light, the LCD's display brightness at large viewing angles can be improved, the gradient of the brightness change starting from the right viewing angle towards the large viewing angles can be moderated, leading to balanced brightness across various viewing angles-hence improved viewing angle performance and user experience.

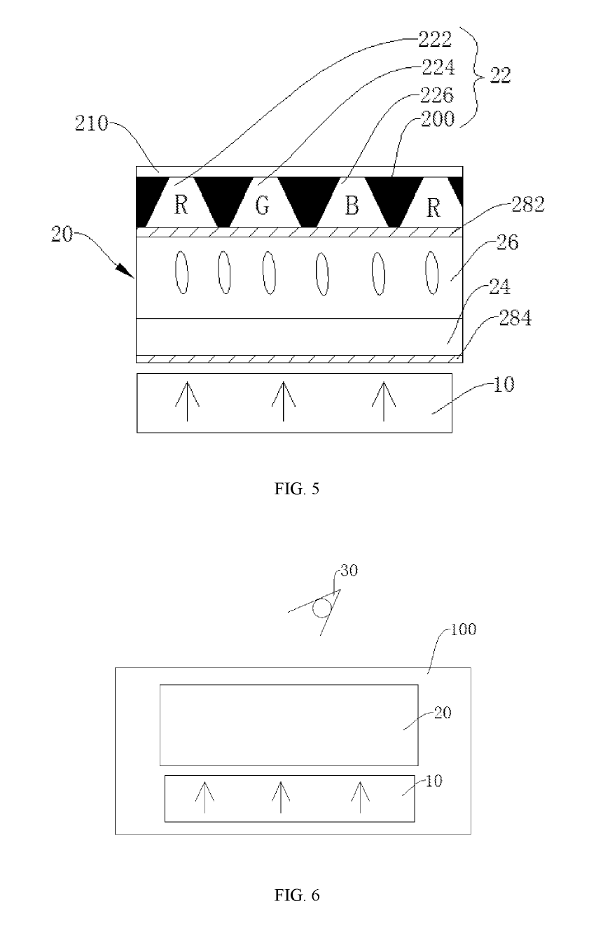

Referring now to FIG. 5, the display panel 20 provided in the third embodiment of the disclosure differs from the second embodiment in that the second polarizer 284 is located on the side of the second substrate 24 away from the liquid crystal layer 26. Specifically, the blue backlight will have been filtered and collimated by the second polarizer 284 before entering the liquid crystal cell, so that the blue backlight passing through the array substrate will be ordered-hence improved transmittance of the blue backlight, i.e., improved utilization rate of the blue backlight and reduced energy consumption.

The display panel 20 provided by this embodiment may further include a transparent cover plate 210 located on the side of the first substrate 22 away from the liquid crystal layer 26. In one implementation, the transparent cover plate 210 is attached to the surface of the first substrate 22. The transparent cover plate 210 may be made of a transparent material such as a glass or plastic. The transparent cover plate 210 is used to protect the display panel 20 to avoid scratching or damaging of the first substrate 22.

As described above, the blue backlight provided by the blue backlight module 10 can sequentially pass through the second substrate 24 and the liquid crystal layer 26 before reaching the first substrate 22. There the blue backlight can excite the red quantum dots to emit red light, and the green quantum dots to emit green light. Thus, the red light and the green light generated by the quantum dot materials can then be scattered in all directions outside the display panel 20. The blue backlight also can transmit through the transparent scattering particles 2260 to emit blue light to the display panel 20, where the transparent scattering particles 2260 can re-scatter the blue backlight. Therefore, by the scattering effects of the blue light having obtained a widened light pattern combined with the red light and the green light, the LCD's display brightness at the large viewing angles can be improved, the gradient of the brightness change starting from the right viewing angle towards the large viewing angles can be moderated, leading to balanced brightness across various viewing angles-hence improved viewing angle performance and user experience.

Referring now to FIG. 6, a display device 100 is further provided in accordance with an embodiment of the disclosure. The display device 100 may include a blue backlight module 10 and a display panel 20. The blue backlight module 10 is located on a side of the second substrate 24 away from the liquid crystal layer 26. The blue backlight module 10 can supply blue backlight to the display panel 20, allowing the display panel 20 to display an image for viewing by the human eye 30. The display device 100 provided by this embodiment includes, but is not limited to, an electronic device for outputting image information, such as a television, a mobile phone, a tablet computer, a notebook computer, and the like.

As described above, the blue backlight provided by the blue backlight module 10 can sequentially pass through the second substrate 24 and the liquid crystal layer 26 before reaching the first substrate 22. There the blue backlight can excite the red quantum dot to emit red light, and the green quantum dots to emit green light. Thus, the red light and the green light generated by the quantum dot materials can then be scattered in all directions outside the display panel 20. The blue backlight also can transmit through the transparent scattering particles 2260 to emit blue light to the display panel 20, where the transparent scattering particles 2260 can re-scatter the blue backlight. Therefore, by the scattering effects of the blue light having obtained a widened light pattern combined with the red light and the green light, the LCD's display brightness at the large viewing angles can be improved, the gradient of the brightness change starting from the right viewing angle towards the large viewing angles can be moderated, leading to balanced brightness across various viewing angles-hence improved viewing angle performance and user experience.

The foregoing description merely depicts some specific embodiments of the disclosure, which however are not intended to limit the disclosure. Any modifications, equivalent substitutions, or improvements made thereto without departing from the spirit and principle of the disclosure shall all be encompassed within the protection of the disclosure. Therefore, the scope of protection of this application shall be subject to the scope of protection of the claims.

1. A display panel disposed opposite to and laminated with a blue backlight module, comprising:
a first substrate;
a second substrate; and
a liquid crystal layer, located between the first substrate and the second substrate; wherein
the first substrate comprises red sub-pixels, green sub-pixels, and blue sub-pixels arranged in an array, with the red sub-pixels filled with red quantum dots, the green sub-pixels filled with green quantum dots, and the blue sub-pixels filled with transparent scattering particles; the blue backlight module is located on a side of the second substrate away from the liquid crystal layer and provides a blue backlight for the display panel, wherein the blue backlight is configured to excite the red quantum dots to scatter red light and the green quantum dots to scatter green light, and configured to be scattered by the transparent scattering particles to increase, together with the red light and the green light, display brightness of the display panel at large viewing angles.

2. The display panel of claim 1, further comprising a first polarizer and a second polarizer, wherein the first polarizer is located between the first substrate and the liquid crystal layer and configured to collimate the blue backlight to increase scattering effect of the blue backlight across the transparent scattering particles, and wherein the second polarizer is located on a side of the liquid crystal layer away from the first polarizer.

3. The display panel of claim 2, wherein the red sub-pixels, the green sub-pixels, and the blue sub-pixels each comprise a light entrance located on a side of the first substrate facing the liquid crystal layer and a light outlet located on a side of the first substrate away from the liquid crystal layer, wherein the light entrance is larger in size than the light outlet to increase angles at which the red light, the green light, and the blue backlight emit from the display panel.

4. The display panel of claim 3, wherein the first substrate further comprises a black matrix arranged among the red sub-pixels, the green sub-pixels, and the blue sub-pixels.

5. The display panel of claim 2, wherein the second polarizer is located on the side of the second substrate away from the liquid crystal layer.

6. The display panel of claim 1, wherein the transparent scattering particles comprise inorganic nano-particles and resin microspheres.

7. The display panel of claim 6, wherein the transparent scattering particles have diameters ranging from 10 nm to 1 μm.

8. The display panel of claim 1, wherein the red quantum dots and the green quantum dots have a material system of acrylic-acid-based, epoxy-based, or polyolefin-based resins.

9. The display panel of claim 1, further comprising a transparent cover plate located on a side of the first substrate away from the liquid crystal layer.

10. A display device, comprising:
a blue backlight module; and
a display panel, comprising:
a first substrate;
a second substrate; and
a liquid crystal layer, located between the first substrate and the second substrate; wherein the first substrate comprises red sub-pixels, green sub-pixels, and blue sub-pixels arranged in an array, with the red sub-pixels filled with red quantum dots, the green sub-pixels filled with green quantum dots, and the blue sub-pixels filled with transparent scattering particles;
wherein the blue backlight module is located on a side of the second substrate away from the liquid crystal layer and provides a blue backlight for the display panel, where the blue backlight is configured to excite the red quantum dots to scatter red light and the green quantum dots to scatter green light, and configured to be scattered by the transparent scattering particles to increase, together with the red light and the green light, display brightness of the display panel at large viewing angles.

11. The display device of claim 10, further comprising a first polarizer and a second polarizer, wherein the first polarizer is located between the first substrate and the liquid crystal layer and configured to collimate the blue backlight to increase the scattering effect of the blue backlight across the transparent scattering particles, and wherein the second polarizer is located on a side of the liquid crystal layer away from the first polarizer.

12. The display device of claim 11, wherein the red sub-pixels, the green sub-pixels, and the blue sub-pixels each comprise a light entrance located on a side of the first substrate facing the liquid crystal layer and a light outlet located on a side of the first substrate away from the liquid crystal layer, wherein the light entrance is larger in size than the light outlet to increase angles at which the red light, the green light, and the blue backlight emit from the display panel.

13. The display device of claim 12, wherein the first substrate further comprises a black matrix arranged among the red sub-pixels, the green sub-pixels, and the blue sub-pixels.

14. The display device of claim 11, wherein the second polarizer is located on the side of the second substrate away from the liquid crystal layer.

15. The display device of claim 10, wherein the transparent scattering particles comprise inorganic nano-particles and resin microspheres.

16. The display device of claim 15, wherein the transparent scattering particles have diameters ranging from 10 nm to 1 μm.

17. The display device of claim 10, wherein the red quantum dots and the green quantum dots have a material system of acrylic-acid-based, epoxy-based, or polyolefin-based resins.

18. The display device of claim 10, further comprising a transparent cover plate located on a side of the first substrate away from the liquid crystal layer.

19. The display panel of claim 4, wherein the black matrix has a trapezoidal shape.

20. The display device of claim 13, wherein the black matrix has a trapezoidal shape.
